(19) United States
(12) Patent Application Publication
(10) Pub. No.: US 2026/0248345 A1
(43) Pub. Date: Aug. 27, 2026

(54) CLEANING TOOL AND ATTACHMENT OF CLEANING ARTICLE THERETO

(71) Applicant: Carl Freudenberg KG, Weinheim (DE)

(72) Inventors: Robert Ancheta, Aurora, IL (US); Doug Metzel, Lombard, IL (US); Eric Martin, St Charles, IL (US)

(73) Assignee: Carl Freudenberg KG, Weinheim (DE)

(21) Appl. No.: 19/061,300

(22) Filed: Feb. 24, 2025

(51) Int. Cl. A47L 13/38; A47L 13/42; B25G 1/06; B25G 3/04

(52) U.S. Cl. CPC A47L 13/38; A47L 13/42; B25G 1/06; B25G 3/04

(57) ABSTRACT

A cleaning tool includes: a first structural member having an attachment hook extending in an axial direction; and a second structural member extending in the axial direction, the second structural member being attached to the first structural member. The attachment hook has an attachment base connecting the attachment hook to the first structural member, an axial section connected to the attachment base, and an insertion portion connected to the axial section. The insertion portion points radially outward with respect to the axial direction.

### FIELD

The present disclosure generally relates to cleaning articles, such as cleaning cloths, and cleaning tools, such as dusting tools. A cleaning article may be used as a refill for a cleaning tool.

### BACKGROUND

Various dusting tools are known in the prior art. For example, FIG. 1 shows a prior art dusting tool 100 that includes a flexible skeletal element 202, to which a dusting cloth 104 may be removably attachable. The dusting tool 100 may include a handle assembly 206 and a selectively pivotable joint 254 that allows the flexible skeletal element 202 and its dusting cloth 104 to be positioned at different angles with respect to handle assembly 206 for different dusting applications. For example, the selectively pivotable joint 254 may rotatably connect a first adjacent member 256 of the handle assembly 206 to a second adjacent member 258, with the flexible skeletal element 202 being attached to the second adjacent member 258. After using the dusting tool 100 for multiple dusting applications, the dusting cloth 104 may become soiled, at which time it may be removed from dusting tool 100 and replaced with a new (i.e., refill) dusting cloth 104.

FIG. 2 shows a detailed view of a prior art dusting tool 100 with selectively pivotable joint 254 rotatably connecting first adjacent member 256 of handle assembly 206 to second adjacent member 258, to which second adjacent member 258 flexible skeletal element 202 is attached. First adjacent member 256 may be rotatable with respect to second adjacent member 258 about axis 260, with a depressible button 247 allowing freedom of rotation between first adjacent member 256 and second adjacent member 258 when depressible button 247 is pressed.

FIG. 3 shows a detailed view of a prior art dusting tool 100 without selectively pivotable joint 254. Flexible skeletal element 202 is thus attached directly to second adjacent member 258, and second adjacent member 258 acts as a handle assembly 206.

While the dusting tool 100 in FIG. 1 has a dusting cloth 104 attached thereto, FIGS. 2–3 show dusting tool 100 without an attached dusting cloth 104. To attach dusting cloth 104 to dusting tool 100, a user of dusting tool 100 would insert flexible skeletal element 202 into a pocket of dusting cloth 104, then pull dusting cloth 104 along a length of flexible skeletal element 202. After sufficiently pulling dusting cloth 104 along that length, a user may then attach a portion of dusting cloth 104 (e.g., using a hole therein) on a projection 280 of dusting tool 100 so as to hold dusting cloth 104 in place on dusting tool 100.

There is a need to improve upon the attachment of dusting cloths on dusting tools.

### SUMMARY

In an embodiment, the present invention provides a cleaning tool, comprising: a first structural member comprising an attachment hook extending in an axial direction; and a second structural member extending in the axial direction, the second structural member being attached to the first structural member, wherein the attachment hook comprises an attachment base connecting the attachment hook to the first structural member, an axial section connected to the attachment base, and an insertion portion connected to the axial section, and wherein the insertion portion points radially outward with respect to the axial direction.

In an embodiment, the present invention provides a method of securing a cleaning article to a cleaning tool having a first structural member attached to a second structural member in an axial direction, the first structural member including an attachment hook extending in the axial direction, the method comprising: inserting the second structural member into the cleaning article; pulling the cleaning article along the second structural member toward the first structural member so as to align an attachment hook hole of the cleaning article with the attachment hook; and pulling the cleaning article radially inward with respect to the axial direction so that at least a first portion of the attachment hook extends through the attachment hook hole, wherein the first portion of the attachment hook points radially outward with respect to the axial direction.

### BRIEF DESCRIPTION OF THE DRAWINGS

FIG. 1 shows a prior art dusting tool with a dusting cloth attached thereto;

FIG. 2 shows a detailed view of a prior art dusting tool with a selectively pivotable joint;

FIG. 3 shows a detailed view of a prior art dusting tool without a selectively pivotable joint;

FIG. 4 shows a detailed view of a cleaning tool according to the present disclosure with a selectively pivotable joint;

FIG. 5 shows a detailed view of a cleaning tool according to the present disclosure without a selectively pivotable joint;

FIG. 6 shows a cleaning article disposed on the cleaning tool of FIG. 4;

FIG. 7 shows engagement and disengagement of a cleaning article from the cleaning tool of FIG. 4;

FIG. 8 shows the cleaning tool of FIG. 5; and

FIGS. 9A–9D show detailed view of a structural member of the cleaning tool of FIG. 4.

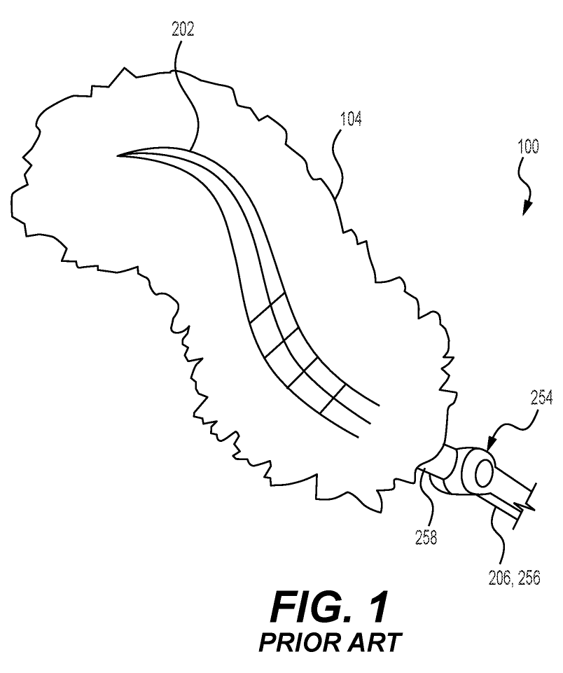

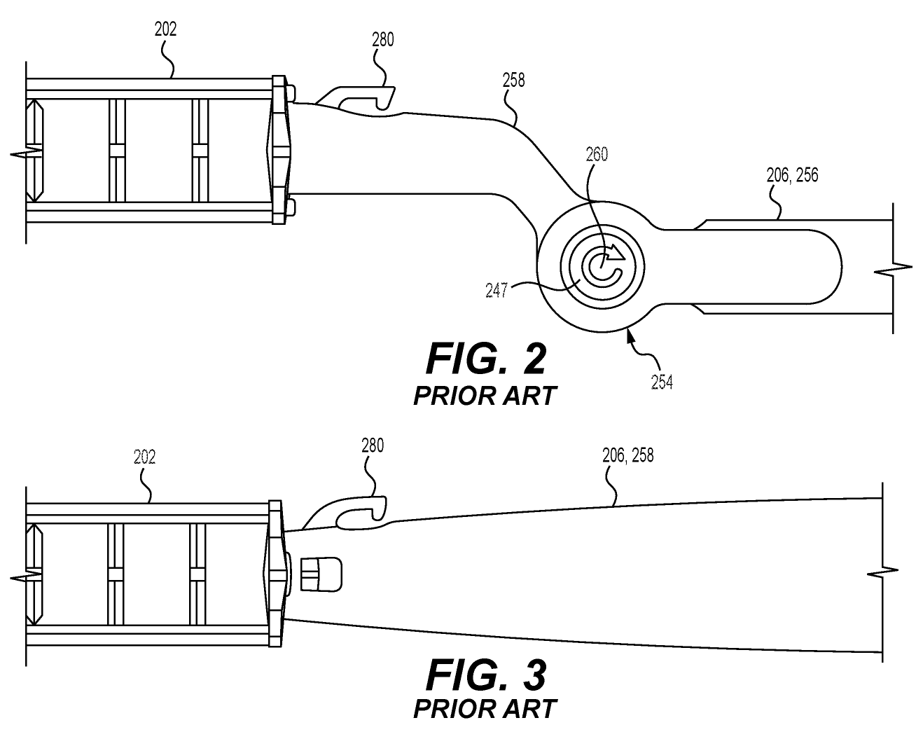

### DETAILED DESCRIPTION

The present disclosure improves upon the attachment of a cleaning article on a cleaning tool. For example, in an embodiment, an increased hook length mitigates the risk of the cleaning article coming off the cleaning tool during dusting. In an embodiment, an upward bend at the end of hook helps a user of the cleaning tool find a hole in the cleaning article and poke the hook through the hole. In an embodiment, installing the cleaning article on the new hook requires a slight pull and stretch. In an embodiment, the attachment hook allows the cleaning article to freely travel and accommodate both the flexed and unflexed states of the cleaning tool. In an embodiment, removing the cleaning article from the attachment hook requires a slight pull and stretch. In an embodiment, the cleaning article can only be removed by slightly stretching the cleaning article over the attachment hook, which stretching does not occur during normal usage of the cleaning tool, all helping to maintain the cleaning article on the cleaning tool. In an embodiment, a structural element of the cleaning tool acts as a spring element to facilitate attachment of the cleaning article to the cleaning tool.

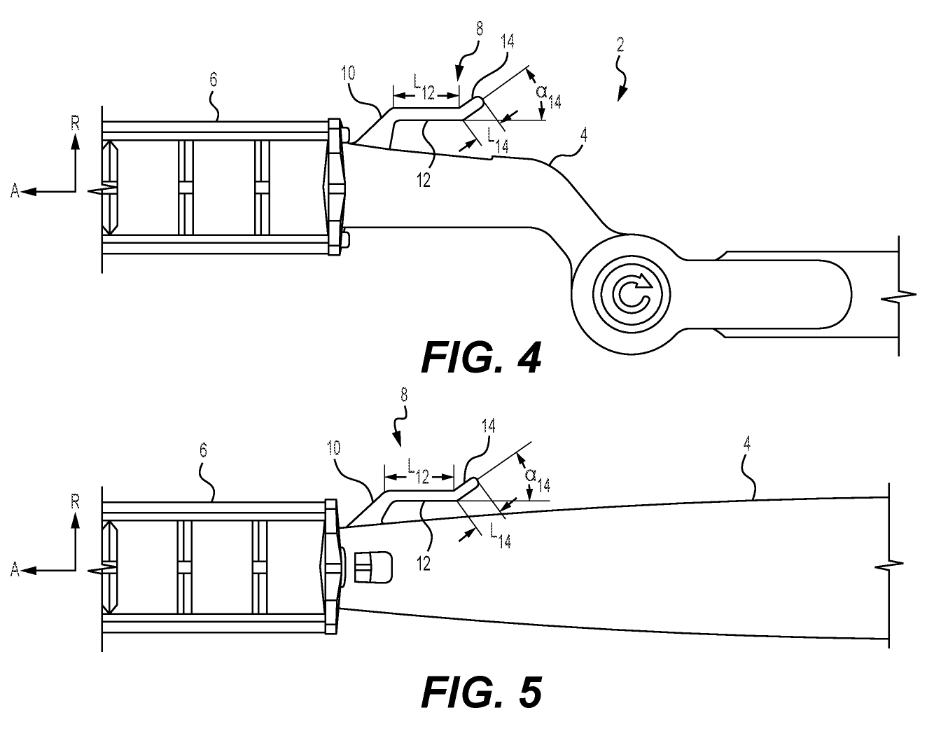

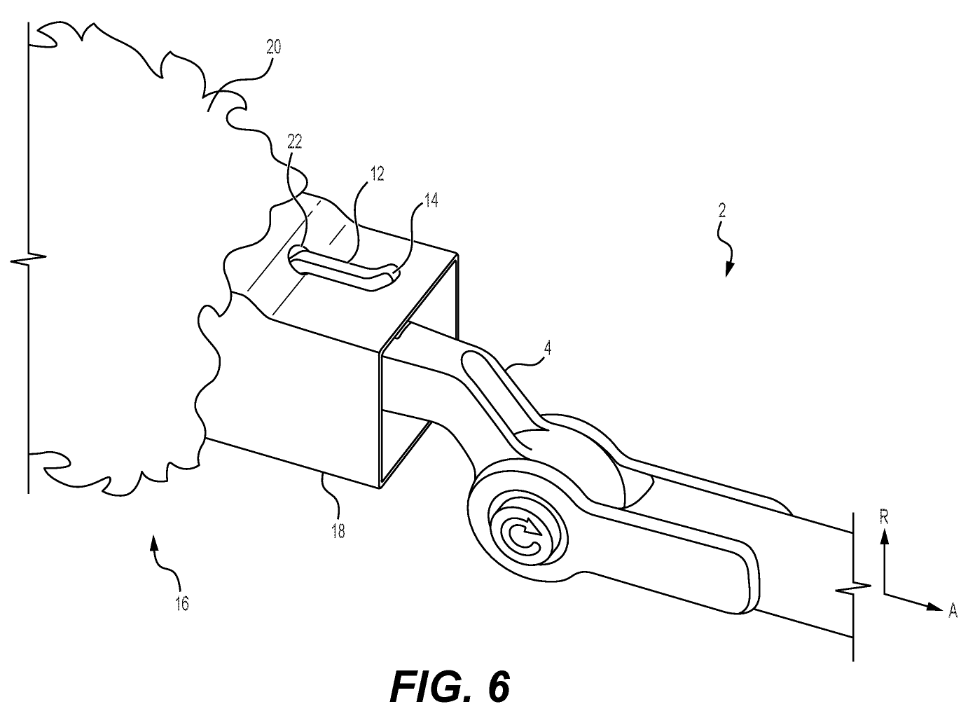

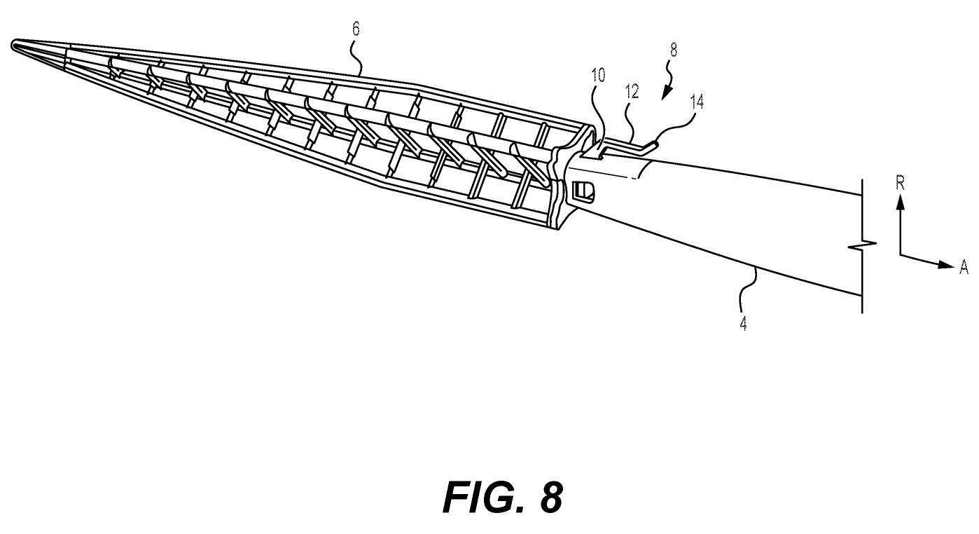

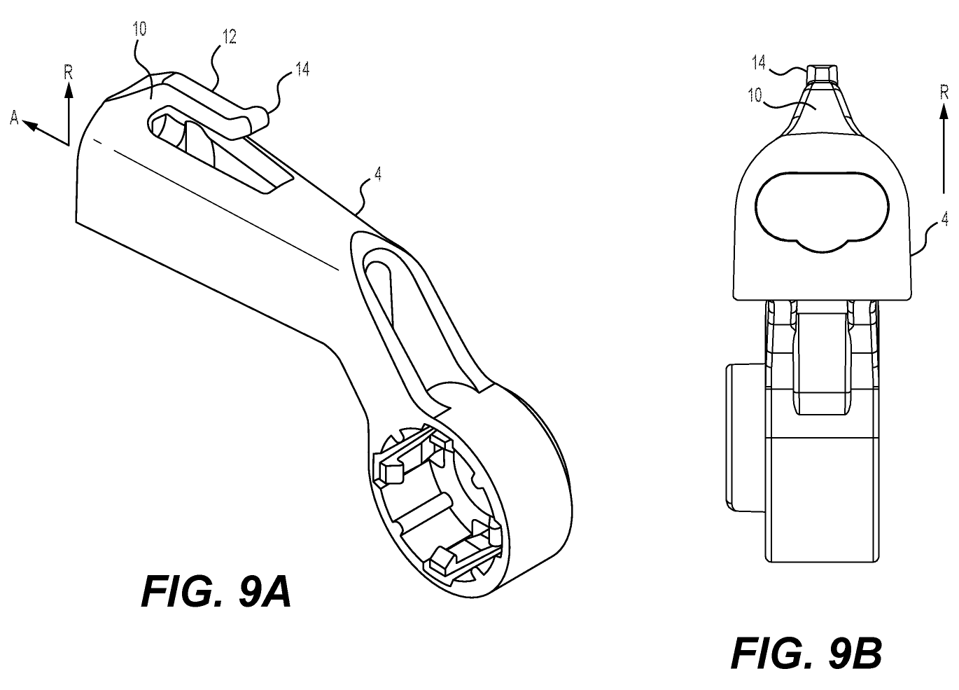

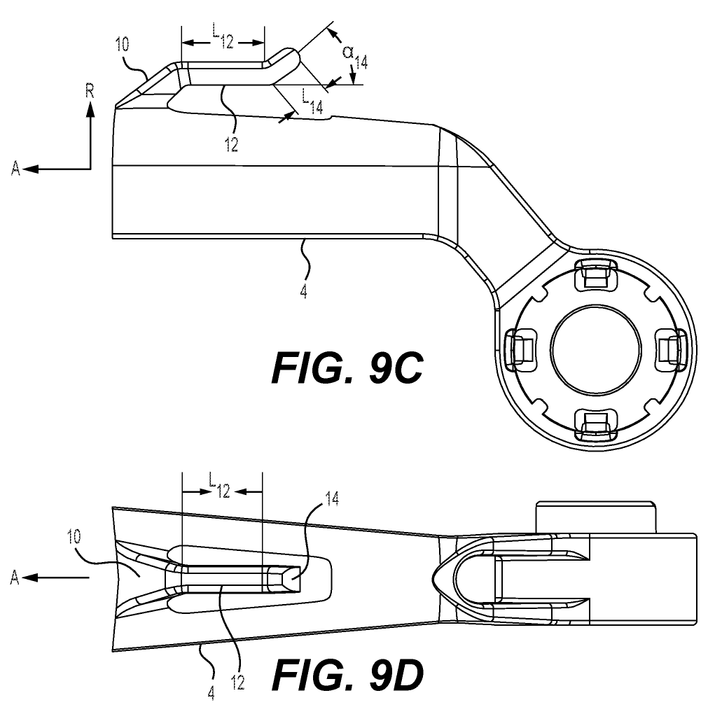

FIGS. 4–9D show a cleaning tool 2 according to the present disclosure. More particularly FIGS. 4, 6, 7 and 9A–9D show cleaning tool 2 with a selectively pivotable joint, while FIGS. 5 and 8 show cleaning tool 2 without a selectively pivotable joint. The discussion herein is equally application to cleaning tools 2 with and without a selectively pivotable joint.

A cleaning tool 2 may include a first structural member 4 comprising an attachment hook 8 extending in an axial direction A, as well as a second structural member 6 extending in the axial direction A. The second structural member 6 may be attached to the first structural member 4. The attachment hook 8 may include an attachment base 10 connecting the attachment hook 8 to the first structural member 4, an axial section 12 connected to the attachment base 10, and an insertion portion 14 connected to the axial section 12. The insertion portion 14 points radially outward with respect to the axial direction A (i.e., in a direction not parallel to axial direction A, such as radial direction R, which is perpendicular to axial direction A, away from the cleaning tool 2).

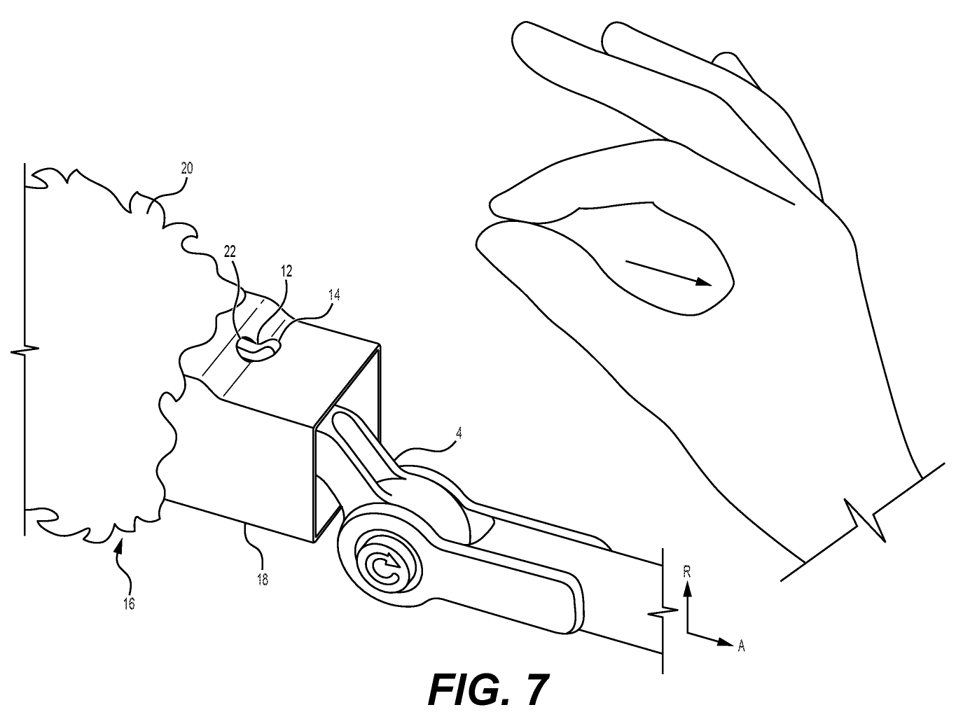

As shown in FIGS. 6–7, the cleaning tool 2 may include a cleaning article 16 disposed on the second structural member 6 (e.g., during a cleaning operation of the cleaning tool 2). The cleaning article 16 may include a fixing portion 18 and a cleaning portion 20 connected to the fixing portion 18. The fixing portion 18 may include an attachment hook hole 22. At least the insertion portion 14 of attachment hook 8 extends through the attachment hook hole 22 of cleaning article 16. During a cleaning operation of the cleaning tool 2, at least the insertion portion 14 remains extended through the attachment hook hole 22. Moreover, During a cleaning operation of the cleaning tool 2, the fixing portion may travel along at least the axial section 12 of attachment hook 8.

At least the insertion portion 14 of attachment hook 8 is engageable with and disengageable from the attachment hook hole 22 by pulling the fixing portion 18 in the axial direction A away from second structural member 6 and toward the first structural member 4, as shown in FIG. 7. At least the insertion portion 14 may be engageable with the attachment hook hole 22 by then pulling the fixing portion 18 in a radial direction R toward the first structural member 4 (i.e., so that the insertion portion 14 at least partially passes through the attachment hook hole 22). Conversely, at least the insertion portion 14 is disengageable from the attachment hook hole 22 by then pulling the fixing portion 18 in a radial direction R away from the first structural member 4 (i.e., so that the insertion portion 14 is no longer engaged with the attachment hook hole 22).

As shown in FIGS. 4–5 and 9C, the insertion portion 14 is at a insertion portion angle α₁₄ with respect to the axial section 12, while at the same time pointing radially outward with respect to the axial direction A (i.e., in a direction not parallel to axial direction A, such as radial direction R, which is perpendicular to axial direction A, away from the cleaning tool 2). In an embodiment, the insertion portion angle α₁₄ is between approximately 25° and 65°, although other values of the insertion portion angle α₁₄ are possible and within the scope of the present disclosure. An insertion portion angle α₁₄ of between approximately 25° and 65° facilitates cleaning article 16 remaining attached to the cleaning tool 2 during a cleaning operation of the cleaning tool 2. More particularly, an insertion portion angle α₁₄ of between approximately 25° and 65° helps pull cleaning article 16, while it is disposed on second structural member 6, toward first structural member 4 due at least in part to the insertion portion 14 protruding out of the attachment hook hole 22. Such an effect would not occur if the insertion portion angle α₁₄ were approximately 0°. Moreover, if the insertion portion angle α₁₄ were approximately 90°, it would be difficult to pass the insertion portion 14 through the attachment hook hole 22 of the cleaning article 16, making it difficult to attach the cleaning article 16 to the cleaning tool 2.

In an embodiment, the second structural member 6 is more flexible than the first structural member 4. In particular, applying an equivalent pressure (e.g., by hand, or by an object to be cleaned during a cleaning operation), causes the second structural member 6 to bend or deform more than the first structural member 4. Such a difference in flexibility increases the effectiveness of the cleaning operation of the cleaning article 16, as the cleaning article 16 can more easily conform to a shape of an object being cleaned. At the same time, the first structural member 4 being less flexible than the second structural member 6 allows a user of the cleaning tool 2 to have better control over the placement of the cleaning article 16 with respect to an object to be cleaned during a cleaning operation.

In an embodiment, an axial section length L₁₂ of the axial section 12 is at least 1 cm, although other axial section lengths L₁₂ are possible and within the scope of the present disclosure. It has been found that an axial section length L₁₂ of at least 1 cm helps maintain the cleaning article 16 on the cleaning tool 2 during a cleaning operation of the cleaning tool 2, at least in part because such an axial section length L₁₂ facilitates travel of the fixing portion 18 of the cleaning article 16 along the axial section length L₁₂ rather than causing the attachment hook hole 22 of the cleaning article 16 to become fully disengaged from the insertion portion 14 of the cleaning tool 2 during a cleaning operation.

In an embodiment, an insertion portion length L₁₄ of the insertion portion 14 is less than the axial section length L₁₂. It has been found that such a configuration facilitates engagement of the insertion portion 14 with the attachment hook hole 22 of the cleaning article 16 when disposing the cleaning article 16 on the cleaning tool 2, while at the same time maintaining the advantages provided by an axial section 12 that is relatively longer than an insertion portion 14 (e.g., maintaining the cleaning article 16 on the cleaning tool 2 during a cleaning operation of the cleaning tool 2).

The present application also describes a method of securing a cleaning article 16 to a cleaning tool 2. The cleaning tool has a first structural member 4 attached to a second structural member 6 in an axial direction A, while the first structural member 4 includes an attachment hook 8 extending in the axial direction A, as shown in FIGS. 4–5 and 8–9D.

The method may include: inserting the second structural member 6 into the cleaning article 16 (i.e., as shown in FIG. 6); pulling the cleaning article 16 along the second structural member 6 toward the first structural member 4 so as to align an attachment hook hole 22 of the cleaning article 16 with the attachment hook 8 (i.e., pulling, with a hand, the cleaning article 16 in the direction of the arrow near the hand shown in FIG. 7); and pulling the cleaning article 16 radially inward with respect to the axial direction A (i.e., in a direction not parallel to axial direction A, such as radial direction R, which is perpendicular to axial direction A, toward the cleaning tool 2), so that at least a first portion of the attachment hook 8 extends through the attachment hook hole 22, as also shown in FIG. 7. The first portion of the attachment hook 8 points radially outward with respect to the axial direction A (i.e., in a direction not parallel to axial direction A, such as radial direction R, which is perpendicular to axial direction A, away from the cleaning tool 2).

During a cleaning operation of the cleaning tool 2, at least a second portion of the attachment hook 8 remains extended through the attachment hook hole 22, as shown, for example, in FIG. 6.

During a cleaning operation of the cleaning tool 2, at least a second portion of the attachment hook 8 may slide axially with respect to the attachment hook hole 22. In this manner, cleaning article 16 remains disposed on cleaning tool 2 during the cleaning operation (i.e., despite movement of the second structural member 6 with respect to the first structural member 4).

Pulling the cleaning article 16 radially outward with respect to the axial direction A (i.e., in a direction not parallel to axial direction A, such as radial direction R, which is perpendicular to axial direction A, away from the cleaning tool 2) disengages the attachment hook 8 from the attachment hook hole 22, as shown in FIG. 7.

In an embodiment, the first portion of the attachment hook 8 may be an insertion portion 14. The insertion portion 14 may be at a insertion portion angle α₁₄ with respect to a second portion of the attachment hook 8 (e.g., axial section 12). In an embodiment, the insertion portion angle α₁₄ is between approximately 25° and 65°, although other values of the insertion portion angle α₁₄ are possible and within the scope of the present disclosure. An insertion portion angle α₁₄ of between approximately 25° and 65° facilitates cleaning article 16 remaining attached to the cleaning tool 2 during a cleaning operation of the cleaning tool 2. More particularly, an insertion portion angle α₁₄ of between approximately 25° and 65° helps pull cleaning article 16, while it is disposed on second structural member 6, toward first structural member 4 due at least in part to the insertion portion 14 protruding out of the attachment hook hole 22. Such an effect would not occur if the insertion portion angle α₁₄ were approximately 0°. Moreover, if the insertion portion angle α₁₄ were approximately 90°, it would be difficult to pass the insertion portion 14 through the attachment hook hole 22 of the cleaning article 16, making it difficult to attach the cleaning article 16 to the cleaning tool 2.

In an embodiment, the second structural member 6 is more flexible than the first structural member 4. In particular, applying an equivalent pressure (e.g., by hand, or by an object to be cleaned during a cleaning operation), causes the second structural member 6 to bend or deform more than the first structural member 4. Such a difference in flexibility increases the effectiveness of the cleaning operation of the cleaning article 16, as the cleaning article 16 can more easily conform to a shape of an object being cleaned. At the same time, the first structural member 4 being less flexible than the second structural member 6 allows a user of the cleaning tool 2 to have better control over the placement of the cleaning article 16 with respect to an object to be cleaned during a cleaning operation.

In an embodiment, a second portion of the attachment hook 8 comprises an axial section 12. In an embodiment, an axial section length L₁₂ of the axial section 12 is at least 1 cm, although other axial section lengths L₁₂ are possible and within the scope of the present disclosure. It has been found that an axial section length L₁₂ of at least 1 cm helps maintain the cleaning article 16 on the cleaning tool 2 during a cleaning operation of the cleaning tool 2, at least in part because such an axial section length L₁₂ facilitates travel of the fixing portion 18 of the cleaning article 16 along the axial section length L₁₂ rather than causing the attachment hook hole 22 of the cleaning article 16 to become fully disengaged from a first portion of the attachment hook 8 (e.g., insertion portion 14) of the cleaning tool 2 during a cleaning operation.

In an embodiment, a first portion of the attachment hook 8 comprises an insertion portion 14. In an embodiment, a first portion insertion portion length L₁₄ of the insertion portion 14 is less than the axial section length L₁₂ of axial section 12. It has been found that such a configuration facilitates engagement of the insertion portion 14 with the attachment hook hole 22 of the cleaning article 16 when disposing the cleaning article 16 on the cleaning tool 2, while at the same time maintaining the advantages provided by a second portion (e.g., axial section 12) that is relatively longer than a first portion (e.g., insertion portion 14) (e.g., maintaining the cleaning article 16 on the cleaning tool 2 during a cleaning operation of the cleaning tool 2).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

2 cleaning tool

4 first structural member

6 second structural member

8 attachment hook

10 attachment base

12 axial section

14 insertion portion

16 cleaning article

18 fixing portion

20 cleaning portion

100 dusting tool

102 flexible skeletal element

104 dusting cloth

106 handle assembly

202 flexible skeletal element

206 handle assembly

247 depressible button

254 selectively pivotable joint

256 first adjacent member

258 second adjacent member

260 axis

280 projection

A axial direction

R radial direction

α₁₄ insertion portion angle

L₁₂ axial section length

L₁₄ insertion portion length

What is claimed is:

1. A cleaning tool, comprising:
a first structural member comprising an attachment hook extending in an axial direction; and
a second structural member extending in the axial direction, the second structural member being attached to the first structural member,
wherein the attachment hook comprises an attachment base connecting the attachment hook to the first structural member, an axial section connected to the attachment base, and an insertion portion connected to the axial section, and
wherein the insertion portion points radially outward with respect to the axial direction.

2. The cleaning tool of claim 1, further comprising:
a cleaning article disposed on the second structural member.

3. The cleaning tool of claim 2, wherein the cleaning article comprises a fixing portion and a cleaning portion connected to the fixing portion, the fixing portion including an attachment hook hole, and
wherein at least the insertion portion extends through the attachment hook hole.

4. The cleaning tool of claim 3, wherein at least the insertion portion remains extended through the attachment hook hole during a cleaning operation of the cleaning tool.

5. The cleaning tool of claim 3, wherein the fixing portion is configured to travel along at least the axial section during a cleaning operation of the cleaning tool.

6. The cleaning tool of claim 3, wherein at least the insertion portion is engageable with and disengageable from the attachment hook hole by pulling the fixing portion in the axial direction away from second structural member and toward the first structural member.

7. The cleaning tool of claim 6, wherein at least the insertion portion is engageable with the attachment hook hole by then pulling the fixing portion in a radial direction toward the first structural member.

8. The cleaning tool of claim 6, wherein at least the insertion portion is disengageable from the attachment hook hole by then pulling the fixing portion in a radial direction away from the first structural member.

9. The cleaning tool of claim 1, wherein the insertion portion is at a insertion portion angle with respect to the axial section, and
wherein the insertion portion angle is between approximately 25° and 65°.

10. The cleaning tool of claim 1, wherein the second structural member is more flexible than the first structural member.

11. The cleaning tool of claim 1, wherein an axial section length of the axial section is at least 1 cm.

12. The cleaning tool of claim 11, wherein an insertion portion length of the insertion portion is less than the axial section length.

13. A method of securing a cleaning article to a cleaning tool having a first structural member attached to a second structural member in an axial direction, the first structural member including an attachment hook extending in the axial direction, the method comprising:
inserting the second structural member into the cleaning article;
pulling the cleaning article along the second structural member toward the first structural member so as to align an attachment hook hole of the cleaning article with the attachment hook; and
pulling the cleaning article radially inward with respect to the axial direction so that at least a first portion of the attachment hook extends through the attachment hook hole,
wherein the first portion of the attachment hook points radially outward with respect to the axial direction.

14. The method of claim 13, wherein, during a cleaning operation of the cleaning tool, at least a second portion of the attachment hook remains extended through the attachment hook hole.

15. The method of claim 13, wherein at least a second portion of the attachment hook slides axially with respect to the attachment hook hole during a cleaning operation of the cleaning tool.

16. The method of claim 13, wherein pulling the cleaning article radially outward with respect to the axial direction disengages the attachment hook from the attachment hook hole.

17. The method of claim 13, wherein the first portion of the attachment hook comprises an insertion portion,
wherein the insertion portion is at a insertion portion angle with respect to a second portion of the attachment hook, and
wherein the insertion portion angle is between approximately 25° and 65°.

18. The method of claim 13, wherein the second structural member is more flexible than the first structural member.

19. The method of claim 14, wherein the second portion of the attachment hook comprises an axial section, and
wherein an axial section length of the axial section is at least 1 cm.

20. The method of claim 19, wherein the first portion of the attachment hook comprises an insertion portion having an insertion portion length, and
wherein an insertion portion length is less than the axial section length.
